(19) United States
(12) Patent Application Publication
(10) Pub. No.: US 2015/0248189 A1
(43) Pub. Date: Sep. 3, 2015

(54) Touch Sensing Systems

(71) Applicant: LIGHT BLUE OPTICS LIMITED, Cambridge Cambridgeshire (GB)

(72) Inventors: Paul Richard Routley, Cambridge (GB); Euan Christopher Smith, Longstanton (GB); Adrian James Cable, San Mateo, CA (US)

(73) Assignee: Light Blue Optics Ltd., Cambridge (GB)

(21) Appl. No.: 14/430,266

(22) PCT Filed: Sep. 12, 2013
(86) PCT No.: PCT/GB2013/052386

§ 371 Date: Mar. 23, 2015

(30) Foreign Application Priority Data
Sep. 26, 2012 (GB) 1217222.7

(51) Int. Cl. G06F 3/042; G06F 3/03; G06F 3/0354

(52) U.S. Cl. CPC G06F 3/0421; G06F 3/03545; G06F 3/0304

(57) ABSTRACT

We describe a touch sensing system comprising a light source to project light defining a touch sheet above a surface; a camera directed to capture a touch sense image from the touch sheet, comprising light scattered by an object; and a signal processor to process the touch sense image to identify a lateral location of the object on the surface. A brightness of the projected light is modulated to define bright, touch detecting intervals and dark intervals. The camera and the light projection are synchronized such that the camera selectively captures scattered light during the touch detecting intervals and rejects ambient light during the dark intervals. The system further comprises a pen. The pen comprises a photodetector to detect the projected light, a first light source detectable by the camera, and a controller coupled to control the first light source such that it is selectively illuminated during touch detecting intervals in synchronism with modulated projected light of the touch sheet.

### CROSS REFERENCE TO RELATED APPLICATION

This application claims priority to GB Application No. GB1217222.7 entitled “Touch Sensing Systems” and filed Sep. 26, 2012 and PCT Application PCT/GB2013/052386 filed Sep. 12, 2013. The entirety of the aforementioned application is incorporated herein by reference for all purposes.

### FIELD OF THE INVENTION

This invention relates to pen-based touch sensing systems and methods which, in embodiments, can be used to provide a touch sensing surface just above a whiteboard, a display screen, or the like.

### BACKGROUND OF THE INVENTION

Conventional infra-red pen-based electronic whiteboards function on the basis of:
A “pen” containing a battery, control electronics and an infra-red LED in the tip, which is turned on when the tip makes contact with the board
A camera attached to the board which determines the position of the pen tip LED and converts it to coordinates, which are passed to a computer (for example over a USB interface)

Unfortunately, the need to illuminate the LED continually while the pen is in contact with the board leads to potentially short pen battery life, which is a critical problem since in many environments (e.g. schools) the pens may be used for many hours a day and battery replacement or recharging may be inconvenient.

We will describe a new electronic whiteboard architecture using an infra-red pen which enables an extremely long battery life (years) at a low cost.

### SUMMARY OF THE INVENTION

According to the present invention there is therefore provided a touch sensing system, the system comprising: a touch sensor optical system to project light defining a touch sheet above a surface; a camera directed to capture a touch sense image from a region including at least a portion of said touch sheet, said touch sense image comprising light scattered from said touch sheet by an object approaching said surface; and a signal processor coupled to said camera, to process a said touch sense image from said camera to identify a lateral location of said object on said surface; wherein a brightness of said projected light is modulated to define bright, touch detecting intervals and dark intervals, and wherein said camera and said light projection are synchronized such that said camera selectively captures said scattered light during said touch detecting intervals to reject ambient light during said dark intervals; the system further comprising: a pen, the pen comprising a photodetector to detect said projected light, a first light source detectable by said camera, and a controller coupled to said photodetector to control said first light source such that light source is selectively illuminated during said touch detecting intervals in synchronism with modulated projected light of said touch sheet detected by said photodetector.

Broadly speaking embodiments of the system make synergistic use of modulation of the touch sheet, employing this modulation both for ambient background light reduction/rejection and at the same time employing this pulsing or modulation to reduce the power consumption in a pen-based system to an extremely low level. In embodiments the battery lifetime approaches the desired lifetime for the pen itself and the pen may be a sealed, disposable item.

In embodiments the modulation may comprise a pulse with modulation of the projected light. Preferably a duty cycle of the touch detecting interval to the dark interval duration is less than 50%, more preferably less than 10%, 5%, 2% or 1%, shorter duty cycles giving a greater overall power saving for the pen.

In embodiments the first light source (LED) operates at the same wavelength as that of the projected light and using a photodetector is effectively switched on by the light sheet. Preferably, therefore, this light source is controlled to be extinguished some time after it is initially triggered, for example after a period of 1 to a few hundred micro seconds, to inhibit the system locking up.

Preferably the pen comprises a tip-touch sensor to sense touch of the tip of the pen onto a surface, for example a whiteboard surface. Then the controller may be configured such that it is activated from a low power state by this signal. Because the touch sheet is close but not coincident with the touch surface, generally 1 to a few mm above this surface, it is preferable that the pen is activated by actual physical touch onto the surface. This is to provide an improved user experience as activation of the pen by the touch sheet slightly away from the physical surface can feel less natural. Further this approach facilitates additional power reduction in the pen—for example an interrupt line of the controller such as a PIC (trade mark) microcontroller may be employed to wake the controller up from a very low power quiescent state when the pen is touched to the surface. Also for this reason it is preferable that the touch sensor comprises a mechanically-operated electrical switch as such an approach by contrast with, say, an active sensor, effectively uses no power. In a simple embodiment such a mechanical switch may comprise a switch to detect touch of the pen tip or tilt of the pen tip away from an axis of the pen—for example the tip of the pen may be mounted on a rocker and/or spring, biased towards a central and/or extended configuration thus mechanically operated when the pen tip comes into contact with the surface.

In embodiments the pen tip may correspond to a “nib” of the pen, and thus in the description of aspects/embodiments of the invention references to the pen tip may be replaced by references to a “nib” of the pen.

The skilled person will appreciate that references to a “pen” in the description of aspects/embodiments of the invention are to be interpreted broadly. Thus “pen” includes wands and other handheld devices usable for indicating a position on a surface, for example of a whiteboard.

Although in some preferred implementations the pen includes a light source to provide a signal back to the touch detection system, and thus operates as an active signal-sending device, in other arrangements the signal-sending device may be passive, for example comprising a reflector, in particular a diffusing retroreflector in the tip of the pen (diffusing into, say, a 30° cone to facilitate detection). With such an arrangement passive scatter of the touch sheet by the pen signals touch of the pen onto the surface, although preferably the pen also includes the “touch-down” sensor previously described.

Thus in a related aspect the invention provides a touch sensing system, the system comprising: a touch sensor optical system to project light defining a touch sheet above a surface; a camera directed to capture a touch sense image from a region including at least a portion of said touch sheet, said touch sense image comprising light scattered from said touch sheet by an object approaching said surface; and a signal processor coupled to said camera, to process a said touch sense image from said camera to identify a lateral location of said object on said surface; wherein a brightness of said projected light is modulated to define bright, touch detecting intervals and dark intervals, and wherein said camera and said light projection are synchronized such that said camera selectively captures said scattered light during said touch detecting intervals to reject ambient light during said dark intervals; the system further comprising; a pen, the pen comprising a reflector towards a tip, a controller, and a tip-touch sensor to sense touch of a tip of said pen at said surface, wherein said controller is coupled to said tip-touch sensor and activated from a low power state on touching of said pen tip onto said surface.

In some preferred embodiments the pen includes a system for indicating a change of state of the pen back to the touch detection system, for example to indicate one or more of: pen-down, pen-up, operation of a pen button, operation of a pen button in combination with pressing the pen against the surface, and so forth. In a preferred implementation therefore the pen includes a transmitter and the touch sensing system includes a corresponding receiver coupled to the signal processor. Preferably the pen transmits at least a pen-up and a pen-down signal, as well as including one or more additional user controls. Additionally or alternatively a transmitted signal from the pen may include a pen identification, for example a pen ID number.

In one preferred implementation the transmitter in the pen comprises a second light source operating at a different wavelength to the first light source and the receiver comprises a corresponding optical detector, for example a photodiode with a narrowband filter. In this way the pen ID/operation/state signal is seen by the photodetector but not by the camera. A particularly preferred modulation technique comprises encoding a signal for transmission by frequency modulation onto the signal from the pen (although the skilled person will appreciate that any other modulation techniques may be employed). It is advantageous in that this approach automatically provides rejection of ambient light (a DC background) and facilitates use of multiple pens simultaneously, where each pen of a set utilizes a distinct frequency. More particularly a first set of one or more frequencies may be assigned to a first pen and a second set of one or more frequencies, all different to the first set, may be assigned to a second pen. Conveniently the pen signals may then be substantially simultaneously decoded by conversion to the frequency domain, for example by performing a time-to-frequency domain conversion such as a fast Fourier transform on the encoded signal to read the set of signals from the pens simultaneously.

It is preferable that the first light source (or retro reflector) presents a small, well-defined “glowing” area to the touch sensing camera. This is because a pen generally has a rather elongated shape and if the illumination is not confined to a relatively small area, as the angle of the pen changes so can the center of mass of the detected light, thus changing the effective detected pen location. Preferably therefore the first light source is arranged to illuminate substantially only an optically diffusing tip of the pen. In embodiments this may be achieved by a light conductor or pipe from the first light source towards the tip of the pen, for example a glass or plastic rod or an optical fiber. Use of a diffusing tip is also advantageous in collecting light for the photo detector, which tends to see light scattered by the tip of the pen onto the surface for example of a whiteboard rather than viewing the light sheet directly.

In embodiments the signal processor may distinguish between light scattered by the object (pen) and light from the first light source and/or the reflected light from the touch sheet by correlating a timing of detection of a new touch object (pen) by the camera and detection of a second signal, for example a pen-down signal from the pen. Thus in embodiments detection software may provide a time window of, say, plus or minus 100 microseconds before and/or after determining a touch event, correlating a signal from the pen such as a pen-up/pen-down signal with the appearance/disappearance of a touch object in the image captured by the touch sensing camera. If a correlation is detected then the new illuminated region (blob) in the captured touch sense image is determined to be a pen.

In related aspects the invention provides a pen for use with a system as described above, the pen comprising the first light source and/or retro reflector and a controller, for example as previously described.

The skilled person will appreciate that although in some preferred embodiments the touch sheet is used to synchronize the pen to the touch detection system, this is not essential and a separate beacon or other projection device may be employed for such synchronization. In such a case other electromagnetic signals than light, for example a radio frequency signal, may be employed for synchronization. Still further embodiments of the above described technique provide some advantages even in a system which does not employ touch detection.

Thus in further aspects the invention provides a touch sensing system comprising: a device to project a signal, said signal having first, detecting intervals and second intervals; and a pen, the pen comprising a light source, a detector to detect said projected signal, and a controller coupled to said detector to control said light source such that the light source is selectively illuminated during said first, detecting intervals in synchronism with said modulated projected signal detected by said detector.

Preferably, however, such a system includes a camera to capture a touch sense image from a region above a surface, a signal processor to identify a lateral location of an object on this surface, and a hardware and/or software system to synchronize the camera to the signal projection so that the camera selectively captures a touch sense image during the first intervals, rejecting or shuttering off signals during the second intervals, to reject ambient background light.

Advantageously any of the above described touch sensing systems may incorporate an image display or projection device to provide a display on the touch sensitive surface. In this way, for example, a touch sensitive electronic whiteboard may be provided.

In a further related aspect the invention provides a method of touch sensing using a touch sensing system, the system comprising: a touch sensor optical system to project light defining a touch sheet above a surface; a camera directed to capture a touch sense image from a region including at least a portion of said touch sheet, said touch sense image comprising light scattered from said touch sheet by an object approaching said surface; and a signal processor coupled to said camera, to process a said touch sense image from said camera to identify a lateral location of said object on said surface; wherein a brightness of said projected light is modulated to define bright, touch detecting intervals and dark intervals, and wherein said camera and said light projection are synchronized such that said camera selectively captures said scattered light during said touch detecting intervals to reject ambient light during said dark intervals; and a pen; the method comprising: sending a signal back from said pen to said touch sensing system in synchronization with said modulated projected light.

As previously mentioned, the sending may be either active, for example using an active light source such as an LED, or passive, for example using a reflector such as a retro reflector, preferably a diffusing retro reflector.

The invention still further provides processor control codes for the above described signal processor such as code to decode and time-correlate a signal from a pen with a change in appearance of a captured touch sense image from the camera. Additionally or alternatively some or all of the processing may be implemented in hardware (electronic circuitry).

### BRIEF DESCRIPTION OF THE DRAWINGS

FIGS. 1a and 1b show, respectively, a vertical cross section view through an example touch sensitive image display device, and details of a sheet of light-based touch sensing system for the device;

FIGS. 2a and 2b show, respectively, a plan view and a side view of an interactive whiteboard incorporating a touch sensitive image display;

FIGS. 3a to 3c show, respectively, an embodiment of a touch sensitive image display device, use of a crude peak locator to find finger centroids, and the resulting finger locations;

FIGS. 4a to 4c show, respectively, a first pen according to an embodiment of the invention showing an LED and photodetector in the pen tip; a second pen according to an embodiment of the invention showing an optical pen design using waveguide tip; and a third pen according to an embodiment of the invention showing an 905 nm IR pen tip with 850 nm backchannel LED;

FIG. 5 shows an electrical block diagram of a pen according to an embodiment of the invention;

FIGS. 6a and 6b show, respectively, a functional flow diagram for operation of the nib LED of the pen of FIG. 5, and an example state machine for operation of the backchannel LED by the microcontroller (CPU) of the pen of FIG. 5; and

FIG. 7 shows an embodiment of a touch sensitive image display device configured to use the pen of FIGS. 5 and 6.

### DETAILED DESCRIPTION OF PREFERRED EMBODIMENTS

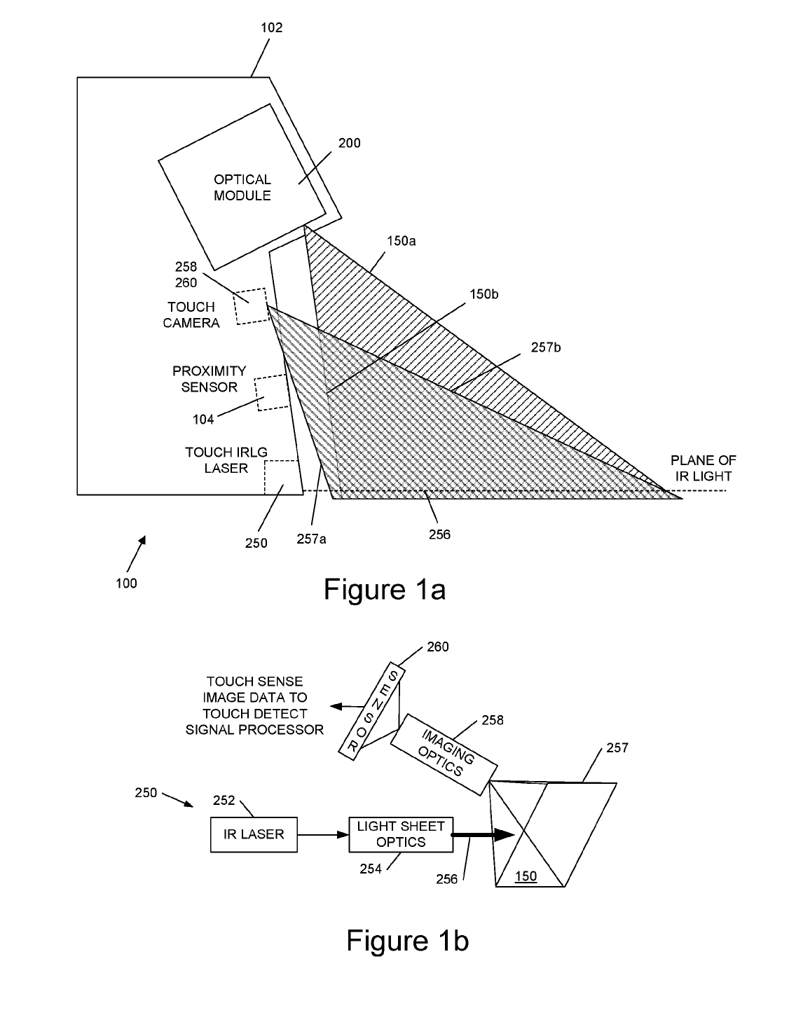

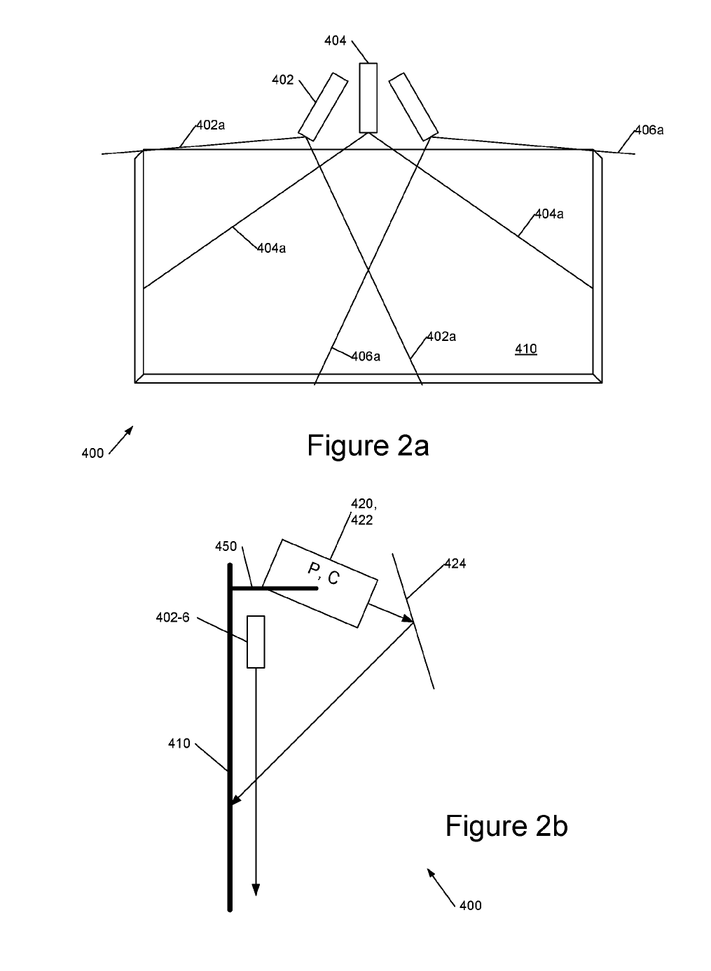

We have previously described touch sensing systems employing a plane or sheet of light, for example as shown in FIGS. 1 and 2. These techniques may be employed for detecting touches or objects proximate to a surface.

FIG. 1 shows an example touch sensitive image projection device 100 comprising an image projection module 200 and a touch sensing system 250, 258, 260 in a housing 102. A proximity sensor 104 may be employed to selectively power-up the device on detection of proximity of a user to the device. The image projection module 200 is configured to project downwards and outwards onto a flat surface such as a tabletop; boundaries of the light forming the displayed image 150 are indicated by lines 150a, b. Suitable image projections include, but are not limited to, digital micromirror-based projectors such as projectors based on DLP™ (Digital Light Processing) technology from Texas Instruments, Inc., and holographic projectors as described in our previously filed patent applications.

The touch sensing system 250, 258, 260 comprises an infrared laser illumination system 250 configured to project a sheet of infrared light 256 just above the surface of the displayed image 150 (for example ˜1 mm above, although in principle the displayed image could be distant from the touch sensing surface). The laser illumination system 250 may comprise an IR LED or laser 252, collimated then expanded in one direction by light sheet optics 254 such as a cylindrical lens. A CMOS imaging sensor (touch camera) 260 is provided with an IR-pass lens 258 and captures light scattered by touching the displayed image 150, with an object such as a finger, through the sheet of infrared light 256 (the boundaries of the CMOS imaging sensor field of view are indicated by lines 257, 257a, b). The touch camera 260 provides an output to touch detect signal processing circuitry as described further later. These techniques may be employed with any type of image projection system.

FIG. 2, this shows plan and side views of an example interactive whiteboard touch sensitive image display device 400 incorporating such a system. In the illustrated example there are three IR fan sources 402, 404, 406, each providing a respective light fan 402a, 404a, 406a spanning approximately 120° together defining a single, continuous sheet of light just above display area 410. The fans overlap on the display area (which is economical as shadowing is most likely in the central region of the display area). Typically such a display area 410 may be of order 1 m by 2 m. The side view of the system illustrates a combined projector 420 and touch image capture camera 422 either aligned side-by-side or sharing a portion of the projection optics. The optical path between the projector/camera and display area is folded by a mirror 424. The sheet of light generated by fans 402a, 404a, and 406a is preferably close to the display area, for example less than 1 cm or 0.5 cm above the display area. However the camera and projector 422, 420 are supported on a support 450 and may project light from a distance of up to around 0.5 m from the display area.

### Example Touch Sensing System

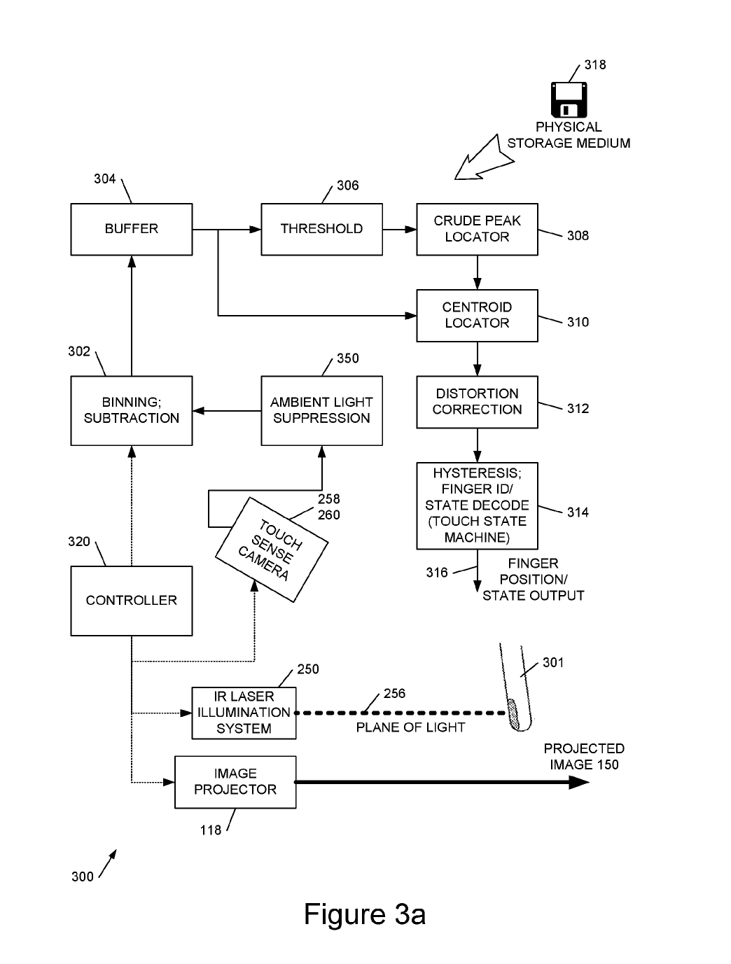

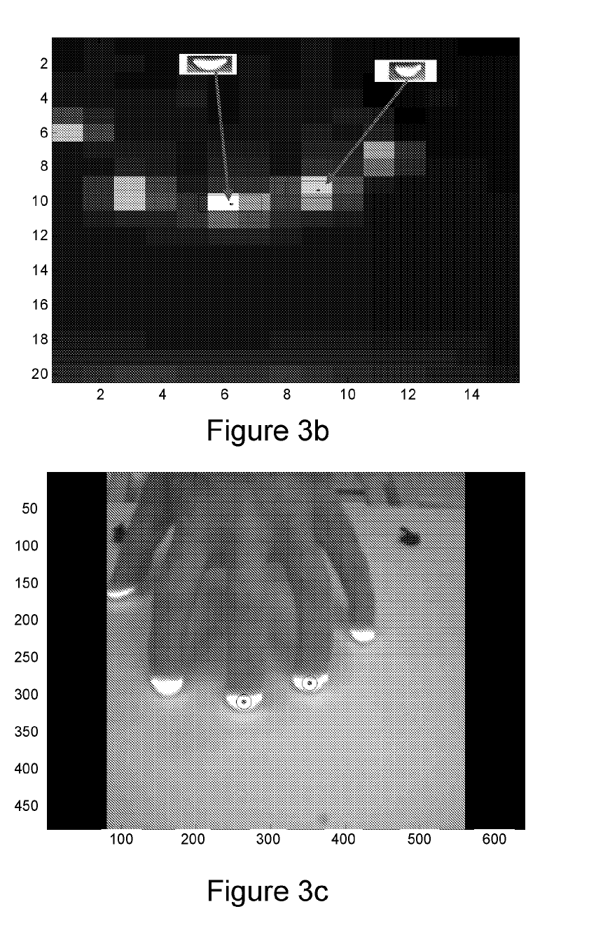

Referring now to FIG. 3a, this shows an embodiment of a touch sensitive image display device 300 according to an aspect of the invention. The system comprises an infra-red laser and optics 250 to generate a plane of light 256 viewed by a touch sense camera 258, 260 as previously described, the camera capturing the scattered light from one or more fingers 301 or other objects interacting with the plane of light. The system also includes an image projector 118, for example a holographic image projector, also as previously described.

In the arrangement of FIG. 3a a controller 320 controls the IR laser on and off, controls the acquisition of images by camera 260 and controls projector 118. In the illustrated example images are captured with the IR laser on and off in alternate frames and touch detection is then performed on the difference of these frames to subtract out any ambient infra-red. The image capture objects 258 preferably also include a notch filter at the laser wavelength which may be around 780-950 nm. Because of laser diode process variations and change of wavelength with temperature this notch may be relatively wide, for example of order 20 nm and thus it is desirable to suppress ambient IR. In the embodiment of FIG. 3a subtraction is performed by module 302 which, in embodiments, is implemented in hardware (an FPGA).

In embodiments module 302 also performs binning of the camera pixels, for example down to approximately 80 by 50 pixels. This helps reduce the subsequent processing power/memory requirements and is described in more detail later. However such binning is optional, depending upon the processing power available, and even where processing power/memory is limited there are other options, as described further later.

Following the binning and subtraction the captured image data is loaded into a buffer 304 for subsequent processing to identify the position of a finger or, in a multi-touch system, fingers.

Because the camera 260 is directed down towards the plane of light at an angle it can be desirable to provide a greater exposure time for portions of the captured image further from the device than for those nearer the device. This can be achieved, for example, with a rolling shutter device, under control of controller 320 setting appropriate camera registers.

Depending upon the processing of the captured touch sense images and/or the brightness of the laser illumination system, differencing alternate frames may not be necessary (for example, where ‘finger shape’ is detected). However where subtraction takes place the camera should have a gamma of substantial unity so that subtraction is performed with a linear signal.

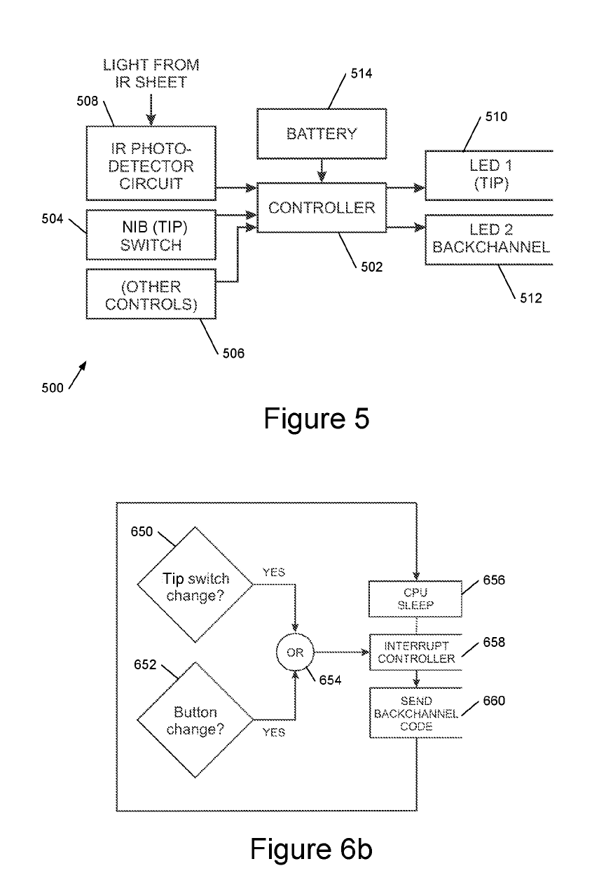

Various different techniques for locating candidate finger/object touch positions will be described. In the illustrated example, however, an approach is employed which detects intensity peaks in the image and then employs a centroid finder to locate candidate finger positions. In embodiments this is performed in software. Processor control code and/or data to implement the aforementioned FPGA and/or software modules shown in FIG. 3 (and also to implement the modules described later with reference to FIG. 5) may be provided on a disk 318 or another physical storage medium.

Thus in embodiments module 306 performs thresholding on a captured image and, in embodiments, this is also employed for image clipping or cropping to define a touch sensitive region. Optionally some image scaling may also be performed in this module. Then a crude peak locator 308 is applied to the thresholded image to identify, approximately, regions in which a finger/object is potentially present.

FIG. 3b illustrates an example such a coarse (decimated) grid. In the Figure the spots indicate the first estimation of the center-of-mass. We then take a 32×20 (say) grid around each of these. This is preferably used in conjunction with a differential approach to minimize noise, i.e. one frame laser on, next laser off.

A centroid locator 310 (center of mass algorithm) is applied to the original (unthresholded) image in buffer 304 at each located peak, to determine a respective candidate finger/object location. FIG. 3c shows the results of the fine-grid position estimation, the spots indicating the finger locations found.

The system then applies distortion correction 312 to compensate for keystone distortion of the captured touch sense image and also, optionally, any distortion such as barrel distortion, from the lens of imaging optics 258. In one embodiment the optical axis of camera 260 is directed downwards at an angle of approximately 70° to the plane of the image and thus the keystone distortion is relatively small, but still significant enough for distortion correction to be desirable.

Because nearer parts of a captured touch sense image may be brighter than further parts, the thresholding may be position sensitive, alternatively position-sensitive scaling may be applied to the image in buffer 304 and a substantially uniform threshold may be applied.

In one embodiment of the crude peak locator 308 the procedure finds a connected region of the captured image by identifying the brightest block within a region (or a block with greater than a threshold brightness), and then locates the next brightest block, and so forth, preferably up to a distance limit (to avoid accidentally performing a flood fill). Centroid location is then performed on a connected region. In embodiments the pixel brightness/intensity values are not squared before the centroid location, to reduce the sensitivity of this technique to noise, interference and the like (which can cause movement of a detected centroid location by more than once pixel).

A simple center-of-mass calculation is sufficient for the purpose of finding a centroid in a given ROI (region of interest), and R(x, y) may be estimated thus:

$$x = \frac{{\sum }_{{y}_{S} = 0}^{Y - 1} {\sum }_{{x}_{S} = 0}^{X - 1} {x}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

$$y = \frac{{\sum }_{{y}_{S} = 0}^{Y - 1} {\sum }_{{x}_{S} = 0}^{X - 1} {y}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

where n is the order of the CoM calculation, and X and Y are the sizes of the ROI.

In embodiments the distortion correction module 312 performs a distortion correction using a polynomial to map between the touch sense camera space and the displayed image space: Say the transformed coordinates from camera space (x, y) into projected space (x′, y′) are related by the bivariate polynomial: x′=xCₓy^{T} x=xCₓy^{T} and y′=xC_{y}y^{T}; where Cₓ and C_{y} represent polynomial coefficients in matrix-form, and x and y are the vectorized powers of x and y respectively. Then we may design Cₓ and C_{y} such that we can assign a projected space grid location (i.e. memory location) by evaluation of the polynomial:

b=└x′┘+X└y′┘

Where X is the number of grid locations in the x-direction in projector space, and └.┘ is the floor operator. The polynomial evaluation may be implemented, say, in Chebyshev form for better precision performance; the coefficients may be assigned at calibration. Further background can be found in our published PCT application WO2010/073024.

Once a set of candidate finger positions has been identified, these are passed to a module 314 which tracks finger/object positions and decodes actions, in particular to identity finger up/down or present/absent events. In embodiments this module also provides some position hysteresis, for example implemented using a digital filter, to reduce position jitter. In a single touch system module 314 need only decode a finger up/finger down state, but in a multi-touch system this module also allocates identifiers to the fingers/objects in the captured images and tracks the identified fingers/objects.

In general the field of view of the touch sense camera system is larger than the displayed image. To improve robustness of the touch sensing system touch events outside the displayed image area (which may be determined by calibration) may be rejected (for example, using appropriate entries in a threshold table of threshold module 306 to clip the crude peak locator outside the image area).

### Ultra-Low-Power Optical Pen for Interactive Whiteboards

The touch technology we describe above employs an infra-red light sheet (of wavelength λ₁ e.g. 905 nm) disposed above (and substantially parallel to) the board and a camera (with a filter to reject light outside a band around λ₁) to detect and locate impingements on the sheet (for example, from fingers), which are translated to touch events. To reject ambient light, the camera exposure period is set very short and the infra-red light sheet is pulsed in synchrony with the camera exposure. As an example, a camera exposure period of 100 us would lead to an infra-red laser duty cycle of 0.6%.

Using this touch architecture, one can add improved infra-red pen support as follows. Using a standard infra-red pen (as described in the Introduction section) as a base, add to the tip an infra-red photodetector (for example, a photodiode) which detects incident infra-red light (at wavelength λ₁), and activates the LED (also at λ₁) only if the detected incident IR light level is sufficiently high (in addition to the tip being in contact with the board).

The IR photodetector's position relative to the tip should be chosen such that, when the pen is in contact with the board, the infra-red light sheet over the board impinges on the photodetector. As a result, the tip LED will activate not continuously but in synchrony with the infra-red light sheet pulse train, and therefore in synchrony with the camera exposure. The result is that the duty cycle of the LED will be reduced from 100% to around 0.46% (assuming a camera exposure period of 100 us), with no decrease in the signal intensity observed by the camera during its exposure period. The pen's power consumption, conventionally dominated by the LED, will fall by several orders of magnitude. As a result, pen battery life will increase concomitantly.

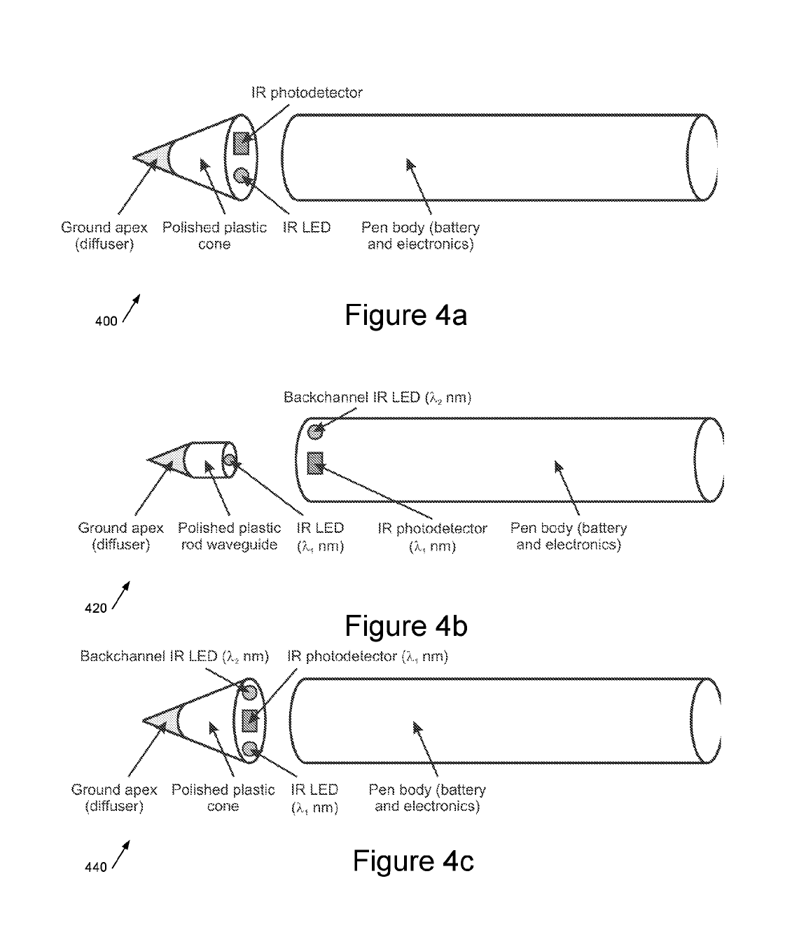

FIG. 4a shows one preferred arrangement of a pen 400 whereby the pen tip comprises a polished plastic cone with the LED and photodetector attached to the base facet of the cone. In the figure, the tip is separated from the pen body for clarity—in a real pen they are attached together mechanically. The tip of the cone is roughened by grinding to provide a diffusing surface, so that light from the LED is emitted by the tip over a wide angular range; and/or the tip may comprise a solid (white) plastic diffuser.

Alternatively, an optical waveguide, such as a polished plastic rod, may be employed to couple the light from the IR LED to the tip of a pen 420 (FIG. 4b) so that only the tip “glows”. The tip, as above, may be roughened to provide diffuse emission of the light. One or more IR photodiodes can be located separately from the waveguide, as shown in FIG. 4b, or also coupled into the waveguide. If the photodiode is separate from the tip, then the infra-red light sheet is likely not to impinge upon it directly, but instead the photodiode can be configured to detect scatter of the IR light sheet from the diffusing tip of the waveguide. In embodiments the photodetector sees the light sheet indirectly, seeing scatter from the tip in the light sheet rather than the light sheet directly (potentially via a reflection from the board), and thus the photodetector does not need to be actually in the light sheet.

Doubtless many other possible configurations of IR LED and photodetector within a pen tip will be apparent to those skilled in the art.

In addition to the above, for systems that do not feature an infra-red light sheet (for example, systems that need to support only pen operation, and not touch), a pulsed infra-red LED can be employed in the system in place of the IR light sheet to provide an optical synchronization signal for the pen, without any hardware changes to the pen.

### Optical Backchannel

Instead of just illuminating the LED continuously for, say, 100 us during the camera exposure, a pulse pattern can be employed within (or subsequent to) this 100 us period to encode additional data to transmit data via an optical backchannel from the pen to an independent photodetector associated with the whiteboard. This additional data can encode, for example, a pen ID, or whether a button on the pen is pressed, to provide additional functionality including multi-pen discrimination.

Additionally or alternatively, instead of the tip LED transmitting the optical backchannel pulse sequence, a second LED (or other signal source such as an RF emitter) can be employed to provide the backchannel—as shown for pen 440 of FIG. 4c. If the second LED has, for example, a different wavelength λ₂ from the tip LED (λ₁), the primary IR position signal (detected by the camera) and the optical backchannel (detected by a separate photodetector) may be separated using appropriate dichroic filters, which may simplify the electronic design and improve robustness. An embodiment of this configuration is shown in FIG. 4c.

FIG. 5 shows a schematic block diagram 500 of circuitry for the pens of FIG. 4. Thus this comprises a micro controller 502, for example a PIC micro controller and an electrical switch 504 operated by pressure of the tip onto the surface on which the pen is employed. This switch may comprise, for example, a misroswitch and/or one or more pairs of spring contacts. The switch(es) may be operated by direct pressure of the pen tip onto/off the surface of, for example, a whiteboard and/or sideways motion of the pen tip produced by such pressure.

This is connected, in one embodiment, to an interrupt line of controller 502 to wake the controller from an ultra low power quiescent state. Optionally one or more further user controls 506 are also coupled to controller 502, optionally to one or more additional interrupt lines of the controller. An infrared detector circuit 508 detects light from the infrared touch sheet and provides a corresponding signal to controller 502, which operates to detect this modulator light and to control a first LED 510 to illuminate the pen tip. Optionally a second LED 512 is also provided, coupled to the controller and operable by controls 506, for example using frequency modulation, to provide a back-channel to the touch detection system. A battery 514 powers the system; this may be sealed within the pen and/or rechargeable.

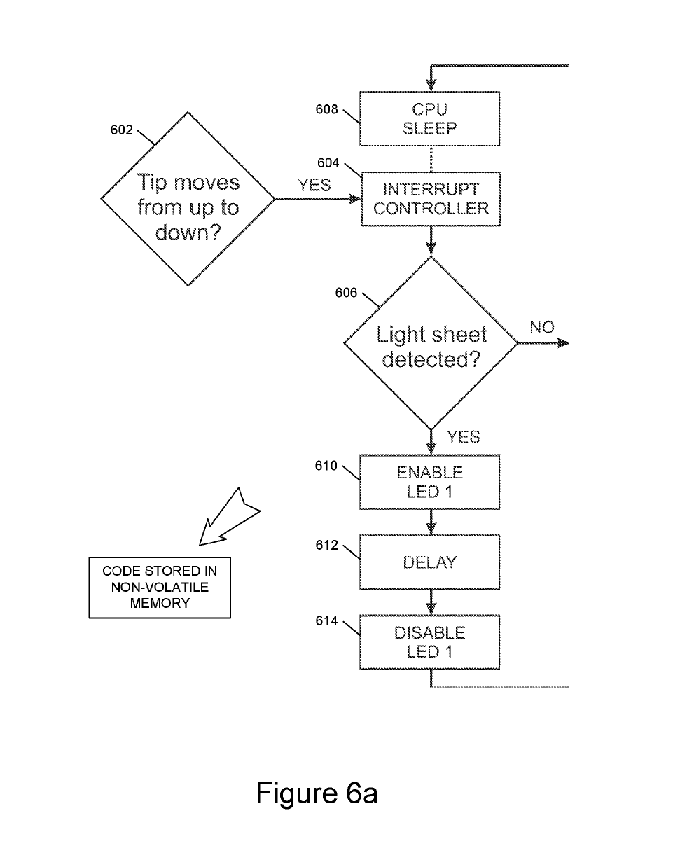

FIG. 6 shows a flow diagram of software operating on controller 502 of FIG. 5. Thus when the tip indicates a pen-down condition 602 and interrupt controller circuit/process 604 begins a procedure which identifies whether the light sheet has been detected 606. If the light sheet has not been detected the controller (CPU) is put back into sleep mode 608. If a light sheet is detected then the first LED light source 510 is enabled 610 and after a timer delay 612, disabled 614, before the controller again returns to sleep mode 608.

In embodiments the pen runs a separate procedure to detect operation of the pen-tip (nib) sensor to identify pen-down/pen-up states and/or operation of one or more user controls (buttons). Thus referring to FIG. 6b if either a change in nib state (650) or a change in button state (652) is detected by an OR function 654 the interrupt controller is alerted beginning an interrupt handling process which sends a back channel code 660 to the touch detection system. The CPU is then put back to sleep 656.

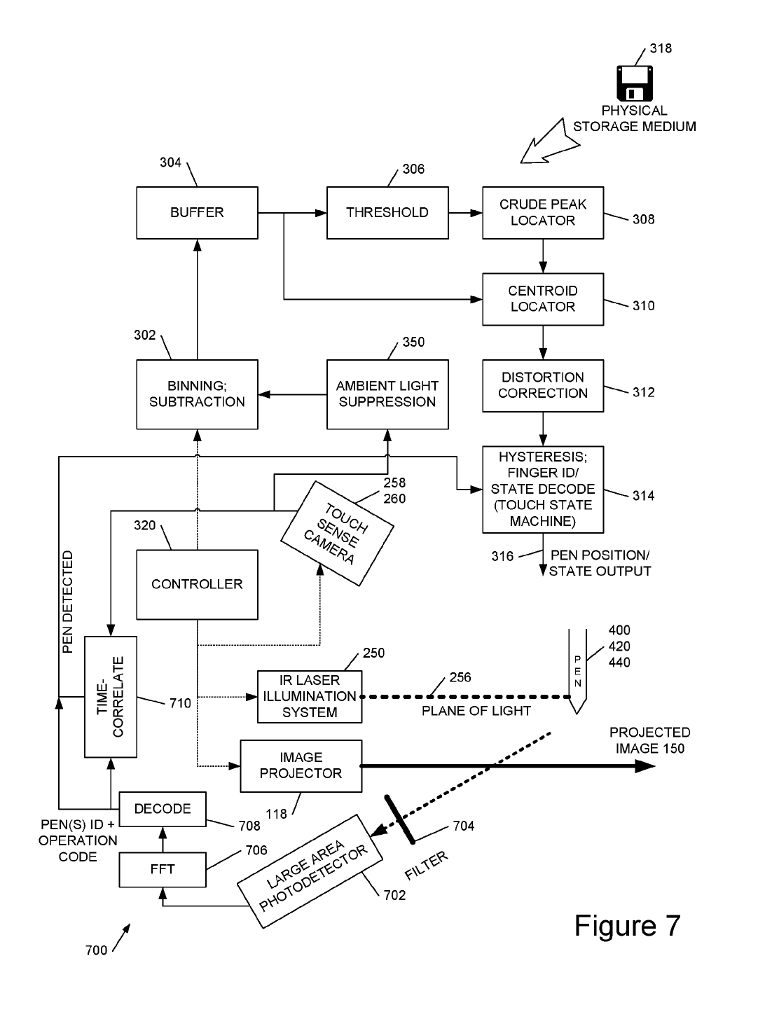

FIG. 7 shows a touch detection system 700 with additional features to the block diagram of FIG. 3a for processing a signal from a pen of the type shown in FIG. 4. Thus a large area photo detector 702 is provided with a narrow band filter 704 to detect light from the second LED 512 back channel of the pen or pens. This signal is converted into the frequency domain 706 and decoded 708 by identifying the one or more frequencies present to determine pen identifiers and/or pen states, for example a pen-down or pen-up signal. The decode module 708 provides a pen detector signal to the time-correlation block 710, indicatively in communication with touch sense camera 260, although in practice there are many points in the signal processing chain of which the correlation may be implemented (compensating for any processing delays as necessary). The time-correlation module 710 correlates a back channel signal from the pen with identification of a new object in the captured touch sense image to provide a pen detective signal to the touch processing module (touch state machine) 314. In addition the pen ID/state information is also provided to the touch state machine to facilitate providing pen ID/state output data from the system.

The low-duty-cycle pulse IR pen-based techniques we have described are particularly useful for implementing an interactive whiteboard but also have advantages in smaller scale touch sensitive displays. Further, some advantages of the techniques we describe are provided even with display systems which are not touch sensitive—and aspects of the invention contemplate use of the above described techniques in such systems.

No doubt many other effective alternatives will occur to the skilled person. It will be understood that the invention is not limited to the described embodiments and encompasses modifications apparent to those skilled in the art lying within the spirit and scope of the claims appended hereto.

1. A touch sensing system, the system comprising:
a touch sensor optical system to project light defining a touch sheet above a surface;
a camera directed to capture a touch sense image from a region including at least a portion of said touch sheet, said touch sense image comprising light scattered from said touch sheet by an object approaching said surface; and
a signal processor coupled to said camera, to process a said touch sense image from said camera to identify a lateral location of said object on said surface;
wherein a brightness of said projected light is modulated to define bright, touch detecting intervals and dark intervals, and wherein said camera and said light projection are synchronised such that said camera selectively captures said scattered light during said touch detecting intervals to reject ambient light during said dark intervals; the system further comprising:
a pen, the pen comprising a photodetector to detect said projected light, a first light source detectable by said camera, and a controller coupled to said photodetector to control said first light source such that light source is selectively illuminated during said touch detecting intervals in synchronism with modulated projected light of said touch sheet detected by said photodetector.

2. A touch sensing system as claimed in claim 1 wherein said first light source has a wavelength corresponding to a wavelength of said projected light, wherein illumination of said first light source is triggered by detection of said projected light by said photodetector, and wherein said first light source is controlled to be extinguished after said illumination.

3. A touch sensing system as claimed in claim 1 or 2 wherein a duty cycle ratio of a touch detecting interval to a dark interval duration is less than 5%.

4. A touch sensing system as claimed in any preceding claim wherein said pen further comprises a tip-touch sensor to sense touch of a tip of said pen at said surface, and wherein said controller is coupled to said tip-touch sensor and activated from a low power state on touching of said pen tip onto said surface.

5. A touch sensing system, the system comprising:
a touch sensor optical system to project light defining a touch sheet above a surface;
a camera directed to capture a touch sense image from a region including at least a portion of said touch sheet, said touch sense image comprising light scattered from said touch sheet by an object approaching said surface; and
a signal processor coupled to said camera, to process a said touch sense image from said camera to identify a lateral location of said object on said surface;
wherein a brightness of said projected light is modulated to define bright, touch detecting intervals and dark intervals, and wherein said camera and said light projection are synchronised such that said camera selectively captures said scattered light during said touch detecting intervals to reject ambient light during said dark intervals; the system further comprising;
a pen, the pen comprising a reflector towards a tip, a controller, and a tip-touch sensor to sense touch of a tip of said pen at said surface, wherein said controller is coupled to said tip-touch sensor and activated from a low power state on touching of said pen tip onto said surface.

6. A touch sensing system as claimed in claim 5 wherein said reflector comprises a diffusing retroflector.

7. A touch sensing system as claimed in claim 4, 5 or 6 wherein said tip touch sensor comprises a mechanically-operated electrical switch.

8. A touch sensing system as claimed in any preceding claim further comprising a receiver, coupled to said signal processor, to receive a signal transmitted from said pen, and wherein said pen comprises a transmitter, coupled to said controller, to transmit a control signal to said signal processor.

9. A touch sensing system as claimed in claim 6 when dependent on claim 4, 5 or 6, wherein said controller is configured to transmit one or both of a pen up to and a pen down signal to said signal processor responsive to said tip-touch sensor.

10. A touch sensing system as claimed in claim 8 or 9 wherein said pen further comprises one or more user controls coupled to said controller, and wherein said controller is configured to transmit an encoded signal denoting a user control in response to operation of said user control.

11. A touch sensing system as claimed in claim 8, 9 or 10 wherein said transmitter comprises a second light source operating at a different wavelength to said first light source, and wherein said receiver comprises an optical detector to detect light at said different wavelength.

12. A touch sensing system as claimed in claim 11 wherein said controller is configured to encode a signal for transmission by said second light source by frequency modulations, and wherein said signal processor is configured to detect an encoded signal from said optical detector in the frequency domain.

13. A touch sensing system as claimed in claim 12 comprising a set of said pens each having a respective set of frequencies, wherein each pen of said set has a different set of said frequencies, and wherein said signal processor is configured to perform a time-to-frequency domain conversion on said encoded signal from said optical detector to read signals from a plurality of said pen simultaneously.

14. A touch sensing system as claimed in any one of claims 1 to 13 wherein a tip of said pen comprises an optical diffuser and wherein said first light source is configured to illuminate substantially only said tip of said pen for said camera.

15. A touch sensing system as claimed in any preceding claim wherein said signal processer is configured to distinguish between light scattered by said object and light from said first light source, or reflected light from the touch sheet, by correlating a timing of detection of a said touch object by said camera and detection of a second signal from said pen.

16. A touch sensing system as claimed in claim 15 when dependent on claim 9, wherein said second signal comprises said pen down signal.

17. A touch sensing system comprising:
a device to project a signal, said signal having first, detecting intervals and second intervals; and
a pen, the pen comprising a light source, a detector to detect said projected signal, and a controller coupled to said detector to control said light source such that the light source is selectively illuminated during said first, detecting intervals in synchronism with said modulated projected signal detected by said detector.

18. A touch sensing system as claimed in claim in claim 17 further comprising:
a camera to capture a touch sense image from a region above a surface comprising a touch object; and
a signal processor coupled to said camera, to process a said touch sense image from said camera to identify a lateral location of said object on surface;
wherein said first light source is detectable by said camera; and
wherein said camera and said signal projection are synchronised such that said camera selectively captures said touch sense image during said first intervals to reject ambient background during said second intervals.

19. A touch sensitive image display device including a touch sensing system as recited in any preceding claim further comprising an image display device to display on said surface.

20. A pen as recited in any preceding claim.

21. A pen for use with the touch sensing system of any one of claims 1 to 19;
the pen comprising a photodetector to detect said projected light, a first light source detectable by said camera, and a controller coupled to said photodetector to control said light source such that light source is selectively illuminated during said touch detecting intervals in synchronism with modulated projected light detected by said photodetector.

22. A pen for use with the touch sensing system of any one of claims 1 to 19,
a pen, the pen comprising a reflector towards a tip, a controller; and
a tip-touch sensor to sense touch of a tip of said pen at said surface;
wherein said controller is coupled to said tip-touch sensor and activated from a low power state on touching of said pen tip onto said surface.

23. A method of touch sensing using a touch sensing system, the system comprising:
a touch sensor optical system to project light defining a touch sheet above a surface;
a camera directed to capture a touch sense image from a region including at least a portion of said touch sheet, said touch sense image comprising light scattered from said touch sheet by an object approaching said surface; and
a signal processor coupled to said camera, to process a said touch sense image from said camera to identify a lateral location of said object on said surface;
wherein a brightness of said projected light is modulated to define bright, touch detecting intervals and dark intervals, and wherein said camera and said light projection are synchronised such that said camera selectively captures said scattered light during said touch detecting intervals to reject ambient light during said dark intervals; and
a pen;
the method comprising:
sending a signal back from said pen to said touch sensing system in synchronisation with said modulated projected light.

24. A method as claimed in claim 23 wherein said sending is active.

25. A method as claimed in claim 23 wherein said sending is passive.
